(19) United States
(12) Patent Application Publication
(10) Pub. No.: US 2026/0018140 A1
(43) Pub. Date: Jan. 15, 2026

(54) DISPLAY CONTROL MODULE AND DISPLAY SYSTEM

(71) Applicant: NEXTPERT INC., New Taipei (TW)

(72) Inventors: HSIN-HUNG LEE, New Taipei (TW); CHENG-FENG YEN, New Taipei (TW); WEN-YI KUO, Taipei (TW)

(21) Appl. No.: 19/265,137

(22) Filed: Jul. 10, 2025

(30) Foreign Application Priority Data
Jul. 10, 2024 (TW) 113125916

(51) Int. Cl. G09G 3/34

(52) U.S. Cl. CPC G09G 3/3406; G09G 2320/0693; G09G 2330/02; G09G 2330/12; G09G 2360/145; G09G 2380/10

(57) ABSTRACT

A display control module and a display system are provided, including a display panel; a first light source group comprising a plurality of first light sources configured to enable the display panel to display images; a second light source group comprising a plurality of second light sources, the first light source group and the second light source group arranged alternately; a sensing unit configured to detect whether the first light source group is abnormal; and a control unit configured to control the second light source group to work when the first light source group is detected to be abnormal by the sensing unit.

### CROSS-REFERENCE TO RELATED APPLICATIONS

This application claims priority to Taiwan Patent Application No. 113125916 filed on Jul. 10, 2024, in Taiwan Intellectual Property Office, the contents of which are incorporated by reference herein.

### FIELD

The subject matter herein generally relates to display technology field, and more particularly to a display control module and a display system for preventing light source disable.

### BACKGROUND

In addition to displaying basic information such as vehicle speed, fuel gauge or electromechanical abnormality warnings in real time, the vehicle display system also needs to display a field of view of the vehicle's surrounding environment provided by an electronic control unit (ECU) on vehicles equipped with a camera monitor system (CMS) to achieve blind spot warning, obstacle prompts and other functions. From this we can see that the vehicle display system is very important for driving safety. Previous technologies usually only detect whether a signal provided by the vehicle host is abnormal, so as to correct the information displayed by the display system when the signal provided by the host is abnormal. However, when the backlight of the display system itself fails, there is currently no effective way to remedy the situation to ensure driving safety.

### BRIEF DESCRIPTION OF THE DRAWINGS

Implementations of the present disclosure will now be described, by way of embodiments, with reference to the attached figures.

FIG. 1 is a schematic diagram of modules of a display system provided in an embodiment of the present application.

FIG. 2 is a circuit diagram of the display system provided by an embodiment of the present application when forming a direct-type planar light source.

FIG. 3 is a schematic diagram of circuit connection of part A in FIG. 2.

FIG. 4 is a circuit diagram of the display system provided by another embodiment of the present application when forming a direct-type planar light source.

FIG. 5 is a schematic diagram showing an arrangement of a first light source group and a second light source group when the display system provided by another embodiment of the present application forms the direct-type planar light source.

FIG. 6 is a partial cross-sectional schematic diagram of the display system shown from the viewing angle a of FIG. 2 when the display system provided by an embodiment of the present application forms the direct-type planar light source.

FIG. 7 is a circuit diagram of the display system provided in an embodiment of the present application when forming an edge-lit planar light source.

FIG. 8 is a partial cross-sectional schematic diagram of the display system shown from the viewing angle b of FIG. 7 when a display panel, the first light source group and the second light source group shown in FIG. 7 together form a backlight module in the edge-lit planar light source.

FIG. 9 is a partial cross-sectional schematic diagram of the display system shown from the viewing angle c of FIG. 7 when the display panel, the first light source group and the second light source group shown in FIG. 7 together form a front light module in the edge-lit planar light source.

FIG. 10 is a schematic diagram of a location of a sensing unit in an embodiment of the present application.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or another word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series, and the like.

In addition to displaying basic information such as vehicle speed, fuel gauge or electromechanical abnormality warnings in real time, the vehicle display system also needs to display a field of view of the vehicle's surrounding environment provided by an electronic control unit (ECU) on vehicles equipped with a camera monitor system (CMS) to achieve blind spot warning, obstacle prompts and other functions. From this we can see that the vehicle display system is very important for driving safety. Previous technologies usually only detect whether a signal provided by the vehicle host is abnormal, so as to correct the information displayed by the display system when the signal provided by the host is abnormal. However, when the backlight of the display system itself fails, there is currently no effective way to remedy the situation to ensure driving safety.

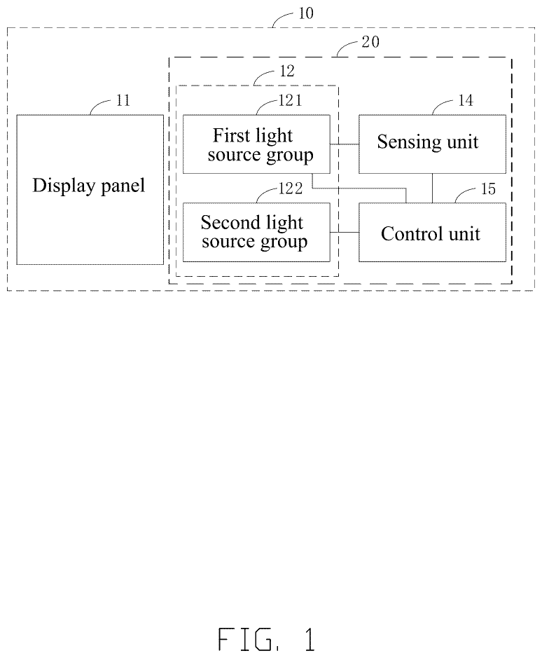

Referring to FIG. 1, the embodiment of the present application provides a display system 10 for preventing light source disable, including a display panel 11, a light source module 12, a sensing unit 14 and a control unit 15. The light source module 12 includes a first light source group 121 and a second light source group 122.

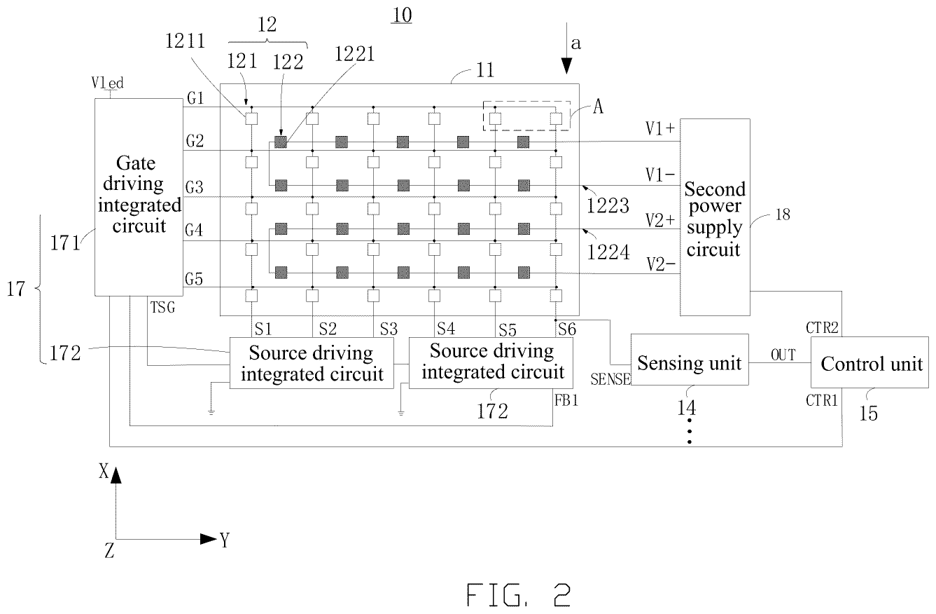

The first light source group 121 includes a plurality of first light sources 1211 (not shown in FIG. 1, please refer to FIG. 2) configured to enable the display panel 11 to display images. For example, the first light source 1211 may be a cold cathode fluorescent lamp (CCFL) or a light-emitting diode (LED). This application takes the first light source 1211 as an LED as an example to illustrate the specific working process of the display system 10.

The second light source group 122 includes a plurality of second light sources 1221 (not shown in FIG. 1, please refer to FIG. 2). The second light source 1221 may also be a cold cathode fluorescent lamp (CCFL) or a light-emitting diode (LED). This application takes the second light source 1221 as an LED as an example to illustrate the specific working process of the display system 10. The first light source group 121 and the second light source group 122 are arranged alternately.

The sensing unit 14 is used to detect whether the first light source group 121 is abnormal (for example short-circuited or open-circuited). The sensing unit 14 can determine whether the first light source group 121 is abnormal by detecting the current flowing through the first light source group 121 or the voltage associated with the first light source group 121, and output a corresponding detection result to the control unit 15.

When the first light source group 121 is abnormal, part of the image of the display system 10 may be missing, thereby affecting driving safety. Thus, the present application obtains the detection result output by the sensing unit 14 through the control unit 15, so that when the first light source group 121 is abnormal, the control unit 15 controls the second light source group 122 to work so that the display panel 11 can display images normally. For example, the control unit 15 may control whether the second light source group 122 is working by controlling a power switch of the second light source group 122. In some embodiments, the control unit 15 may further control the first light source group 121 to stop working when the first light source group 121 is abnormal.

In summary, the display system 10 for preventing light source disable provided in the present application is configured by setting the first light source group 121 and the second light source group 122, and the first light source group 121 and the second light source group 122 are staggered, so that when the first light source group 121 is abnormal, the second light source group 122 is controlled to work so that the display panel 11 can display the image.

### Scene 1

Please continue to refer to FIG. 2, which is a circuit diagram of the display system 10 provided in an embodiment of the present application when forming a direct-type planar light source. In some embodiments, the first light source group 121 and the second light source group 122 of the display system 10 are both arranged in an active area of the display panel 11 to form a direct-type planar light source. The first light source group 121 and the second light source group 122 are both arranged on a side of the display panel 11 away from the user. Furthermore, the light emitted by the first light source group 121 and the second light source group 122 are substantially perpendicular to a plane where the display panel 11 is located. The active area of the display panel 11 refers to a total area of the display panel 11 that can display images and/or texts. The first light source group 121 and the second light source group 122 are both arranged in the active area of the display panel 11, which means that a projection area of the positions where the first light source group 121 and the second light source group 122 are arranged along the Z-axis direction of the display system 10 overlaps with a projection area of the active area of the display panel 11 along the Z-axis direction of the display system 10.

The first light source group 121 and the second light source group 122 are arranged evenly and staggered. Specifically, the plurality of first light sources 1211 are arranged in rows and uniformly arranged within the active area of the display panel 11. In each row, every two adjacent first light sources 1211 are spaced apart by a preset distance. The plurality of second light sources 1221 are also arranged in a row and evenly arranged in the active area of the display panel 11. A row of second light sources 1221 is arranged between every two rows of first light sources 1211, and each row of second light sources 1221 is staggered with the first light sources 1211 in two adjacent rows. In this way, when the first light source group 121 is abnormal and the control unit 15 controls the second light source group 122 to work, the light of the display panel 11 can be kept as uniform as possible, thereby reducing the impact on the display system 10.

In some embodiments, the control unit 15 controls an operating power of the second light source group 122 to be equal to or less than an operating power of the first light source group 121. In other embodiments, a color saturation of the second light source group 122 is equal to or less than a color saturation of the first light source group 121, and/or a brightness of the second light source group 122 is equal to or less than a brightness of the first light source group 121. More specifically, in some specific embodiments, the operating power of the second light source group 122 is less than the operating power of the first light source group 121. In some other specific embodiments, the color saturation of the second light source group 122 is smaller than the color saturation of the first light source group 121, and/or the brightness of the second light source group 122 is smaller than the brightness of the first light source group 121. In this way, the manufacturing cost of the display system 10 can be further reduced, therefore, the normal display of the display panel 11 when the first light source group 121 is abnormal can be ensured at a lower cost, thereby ensuring driving safety.

In some embodiments, the display system 10 further includes a first power supply circuit 17 and a second power supply circuit 18. The first power supply circuit 17 is electrically connected to the first light source group 121 for supplying power to the first light source group 121; the second power supply circuit 18 is electrically connected to the second light source group 122 for supplying power to the second light source group 122. When the control unit 15 determines that the number of abnormal first light sources 1211 of the first light source group 121 reaches a preset range, the control unit 15 controls the second power supply circuit 18 to supply power to the second light source group 122.

In some embodiments, the first power supply circuit 17 is used to provide a working current to the first light source group 121. The first power supply circuit 17 includes at least one gate driving integrated circuit 171 and at least one source driving integrated circuit 172. The at least one gate driving integrated circuit 171 and the at least one source driving integrated circuit 172 are used to jointly drive the first light source group 121 to achieve local dimming of the first light source group 121. Each gate driving integrated circuit 171 includes a plurality of gate lines Gn (n is a positive integer, indicating the n^{th} gate line), such as the gate lines G1-G5 shown in FIG. 2. Each source driving integrated circuit 172 includes a plurality of source lines Sk (k is a positive integer, indicating the k^{th} source line), such as the source lines S1-S6 shown in FIG. 2. The first light sources 1211 in the same row are connected to the same gate line. The first light sources 1211 in the same column are connected to the same source line. In the following, the working principle of the display system 10 is explained by taking the first power supply circuit 17 including a gate driving integrated circuit 171 and two source driving integrated circuits 172 shown in FIG. 2 as an example.

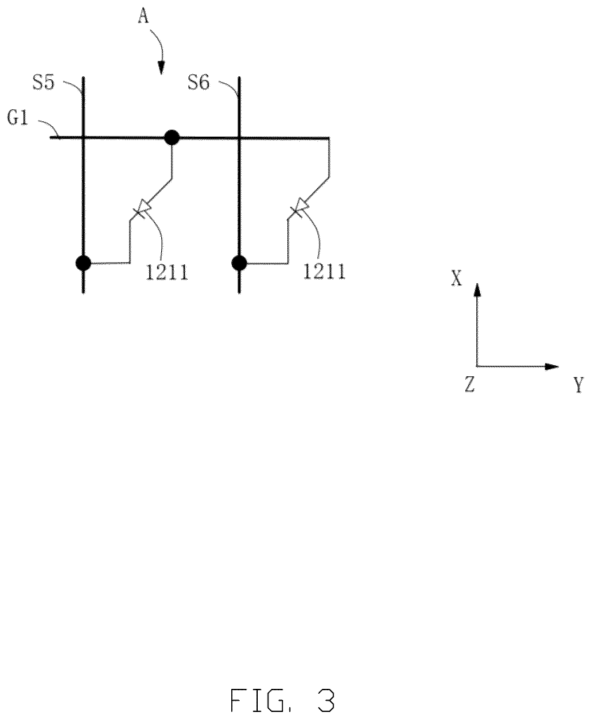

Please refer to FIG. 2 and FIG. 3, FIG. 3 is a schematic diagram of the circuit connection of the two first light sources 1211 in an area A framed in the upper right corner of FIG. 2. Taking the first light sources 1211 as an example of light-emitting diodes, the anodes of the two first light sources 1211 located in the first row are electrically connected to the gate line G1, the cathode of the first light source 1211 located in the 5^{th} column is electrically connected to the source line S5, and the cathode of the first light source 1211 located in the 6^{th} column is electrically connected to the source line S6. That is, in the first light source group 121, the anode of each first light source 1211 in the same row is connected to the corresponding same gate line, and the cathode of each first light source 1211 in the same column is connected to the corresponding source line. Thus, when the gate line electrically connected to the first light source 1211 is turned on to output a DC voltage, and the source line electrically connected to the first light source 1211 is turned on to be grounded, the first light source 1211 can form a complete electrical circuit to emit light.

The control unit 15 is connected (the connection referred to in this application can be an electrical connection or a communication connection based on a wireless signal) to the gate driving integrated circuit 171, and is used to output a first control signal CTR1 to the gate driving integrated circuit 171, so as to control the gate driving integrated circuit 171 to start or stop working according to the level state of the first control signal CTR1.

The gate driving integrated circuit 171 is electrically connected to a power supply Vled, and is used for receiving the direct current outputted by the power supply Vled, and outputting a direct current with a corresponding current value to drive the corresponding first light source 1211 to turn on when the gate line is turned on. The gate lines on the gate driving integrated circuit 171 are turned on in a timing sequence. For example, the control unit 15 may output a corresponding timing signal to the gate driving integrated circuit 171 so that the gate line on the gate driving integrated circuit 171 is turned on according to the timing.

The gate driving integrated circuit 171 is further connected to the at least one source driving integrated circuit 172 for outputting another timing signal TSG to the at least one source driving integrated circuit 172. When the at least one source driving integrated circuit 172 is a plurality of source driving integrated circuits 172, the source driving integrated circuit 172 that receives the timing signal TSG also sends the timing signal TSG to other source driving integrated circuits 172 in sequence. The timing signal TSG is used to enable all source lines to be turned on in a timing sequence. The at least one source driving integrated circuit 172 is also connected to the gate driving integrated circuit 171 for outputting a first feedback signal FB1 to the gate driving integrated circuit 171 to inform the gate driving integrated circuit 171 that all source driving integrated circuits 172 have received the timing signal TSG. For example, in some embodiments, a plurality of source driving integrated circuits 172 are connected in series to form a link. After receiving the timing signal TSG, the source driving integrated circuit 172 at one end of the link sends the timing signal TSG to an adjacent source driving integrated circuit 172, and the adjacent source driving integrated circuit 172 continues to send the timing signal TSG to the next adjacent source driving integrated circuit 172 until the timing signal TSG is transmitted to the source driving integrated circuit 172 at the other end of the link. After receiving the timing signal TSG, the source driving integrated circuit 172 at the other end of the link outputs a first feedback signal FB1 to the gate driving integrated circuit 171 to inform the gate driving integrated circuit 171 that all source driving integrated circuits 172 have received the timing signal TSG. When the gate driving integrated circuit 171 does not receive the first feedback signal FB1 within a preset time after outputting the timing signal TSG, the gate driving integrated circuit 171 determines that the plurality of source driving integrated circuits 172 connected in series are abnormal and actively reports the abnormality to the control unit 15.

When the gate driving integrated circuit 171 and each source driving integrated circuit 172 are turned on in sequence, the gate line and the source line connected to the first light source 1211 are turned on at the same time, the corresponding first light source 1211 is turned on to emit light.

In other embodiments, the first power supply circuit 17 may also include two gate driving integrated circuits 171 and a source driving integrated circuit 172, or the first power supply circuit 17 includes a gate driving integrated circuit 171 and a source driving integrated circuit 172, or the first power supply circuit 17 includes two or more gate driving integrated circuits 171 and two or more source driving integrated circuits 172. The present application does not limit the specific circuit structure of the first power supply circuit 17.

Referring to FIG. 2, in some embodiments, the display system 10 can include a plurality of sensing units 14. The sensing units 14 are arranged on the first power supply circuit 17. FIG. 2 takes the sensor units 14 connected to the source line S6 as an example to illustrate the working principle of the sensor unit 14. The number of sensing units 14 can be equal to the number of source lines, and each sensing unit 14 detects the voltage on the corresponding source line by obtaining the SENSE signal on the corresponding source line. Each sensing unit 14 also outputs a detection result signal OUT to the control unit 15, and the corresponding detection result is represented by the level state of the detection result signal OUT. The sensing unit 14 includes a voltage sensing element or a current sensing element. The voltage sensing element is used to detect whether a voltage of the first light source group 121 is greater than a preset voltage range. When the voltage sensing element detects that the voltage of the first light source group 121 is not within the preset voltage range, determining that the first light source group 121 is abnormal. The current sensing element is used to detect whether a current of the first light source group 121 is greater than a preset current range. When the current sensing element detects that the current of the first light source group 121 is not within the preset current range, determining that the first light source group 121 is abnormal. In some embodiments, the current sensing element includes resistance detection type sensing elements and magnetic field detection type sensing elements.

For example, when the sensing unit 14 includes the current sensing element, when the voltage sensing element of the sensing unit 14 detects that the voltage of the SENSE signal obtained on the corresponding source line is greater than a preset voltage threshold, determining that the corresponding source line is abnormal or the first light source 1211 on this source line is abnormal. At this time, the sensing unit 14 outputs a detection result signal OUT with a high-level state to the control unit 15. In this way, the control unit 15 determines that the corresponding source line is abnormal based on the detection result signal OUT with the high-level state, and there may be a first light source 1211 that cannot emit light normally on this source line. Correspondingly, when the sensing unit 14 detects that the voltage of the SENSE signal obtained on the corresponding source line is less than or equal to the preset voltage threshold, determining that no abnormality has occurred on the corresponding source line. At this time, the sensing unit 14 outputs a detection result signal OUT with a low-level state to the control unit 15. In this way, the control unit 15 determines that the corresponding source line is in a normal state based on the detection result signal OUT with the low-level state.

This application does not impose restrictions on the method of determining the detection results by the signal SENSE. For example, in other embodiments, it can also be provided that when the sensing unit 14 detects that the voltage of the obtained signal SENSE on the corresponding source line is less than a first preset voltage threshold or greater than a second preset voltage threshold, determining that the corresponding source terminal line is abnormal or that there is an abnormal circuit on this source line. The second preset voltage threshold is greater than the first preset voltage threshold.

This application also does not impose restrictions on the method of determining the detection result by the level state of the detection result signal OUT. For example, in other embodiments, when the sensing unit 14 determines that the corresponding source line is abnormal or there is an abnormal loop on that source line, the sensing unit 14 outputs the detection result signal OUT with a low level state to the control unit 15 at this time. In this way, the control unit 15 determines that the corresponding source line is abnormal based on the detection result signal OUT of the low level state, and there may be a first light source 1211 that cannot emit light normally on this source line.

Furthermore, when the control unit 15 determines that the corresponding source line is abnormal and there may be a first light source 1211 that cannot emit light normally on this source line, the control unit 15 can also determine the abnormal first light source 1211 based on the timing signal of the control gate driving integrated circuit 171. For instance, when the control unit 15 determines that the source line S1 is abnormal, if the control unit 15 determines that the gate line G1 is conducting at this time based on the timing signal of the control gate driving integrated circuit 171 at this moment, then the control unit 15 determines that the first light source 1211 located in the first row and first column is abnormal.

Please refer to FIG. 2 again, the second power supply circuit 18, for example, can be a driving integrated circuit. The second power supply circuit 18 is used to receive the DC power output from a DC power source (not shown in the figures) and convert it into a DC voltage suitable for driving the second light source group 122 to generate electricity, thereby supplying power to the second light source group 122. The second power supply circuit 18 is connected to the control unit 15 and is used for receiving the second control signal CTR2 outputted by the control unit 15 so as to control the operation of the second light source group 122 according to the level state of the second control signal CTR2.

In some embodiments, the plurality of second light sources 1221 of the second light source group 122 form at least one passage. Each passage includes at least one second light source 1221 connected in series. In some embodiments, the at least one passage may include a first passage 1223 and a second passage 1224. The first passage 1223 and the second passage 1224 each include a plurality of second light sources 1221 connected in series. The second power supply circuit 18 includes a first positive terminal V1+, a first negative terminal V1−, a second positive terminal V2+, and a second negative terminal V2−. Two ends of the first passage 1223 are connected to the first positive terminal V1+ and the first negative terminal V1−, respectively. Two ends of the second passage 1224 are connected to the second positive terminal V2+ and the second negative terminal V2−, respectively. In this way, the second power supply circuit 18 can drive all the second light sources 1221 of the second light source group 122 to emit light simultaneously. Specifically, in some embodiments, when the level state of the second control signal CTR2 is a high level state, the second power supply circuit 18 receives the DC power output by the DC power supply, and outputs corresponding voltages to the first passage 1223 and the second passage 1224 through the first positive terminal V1+ and the second positive terminal V2+, respectively, to drive the second light sources 1221 on the first passage 1223 and the second passage 1224 to emit light.

The present application also does not limit the manner in which the operation of the second light source group 122 is controlled by the level state of the second control signal CTR2. For example, in other embodiments, when the level state of the second control signal CTR2 is a low level state, the second power supply circuit 18 receives the DC power output by the DC power supply, and outputs corresponding voltages to the first passage 1223 and the second passage 1224 through the first positive terminal V1+ and the second positive terminal V2+, respectively, to drive the second light sources 1221 on the first passage 1223 and the second passage 1224 to emit light.

In some embodiments, when the control unit 15 confirms that the number of abnormal first light sources 1211 on the first light source group 121 reaches a preset value, or two adjacent first light sources 1211 on the first light source group 121 (for example, two adjacent first light sources 1211 on the same row or the same column) are both abnormal, the control unit 15 outputs the second control signal CTR2 in a high level state to the second power supply circuit 18 to control the second light source group 122 to operate, thereby allowing the display panel 11 to display images.

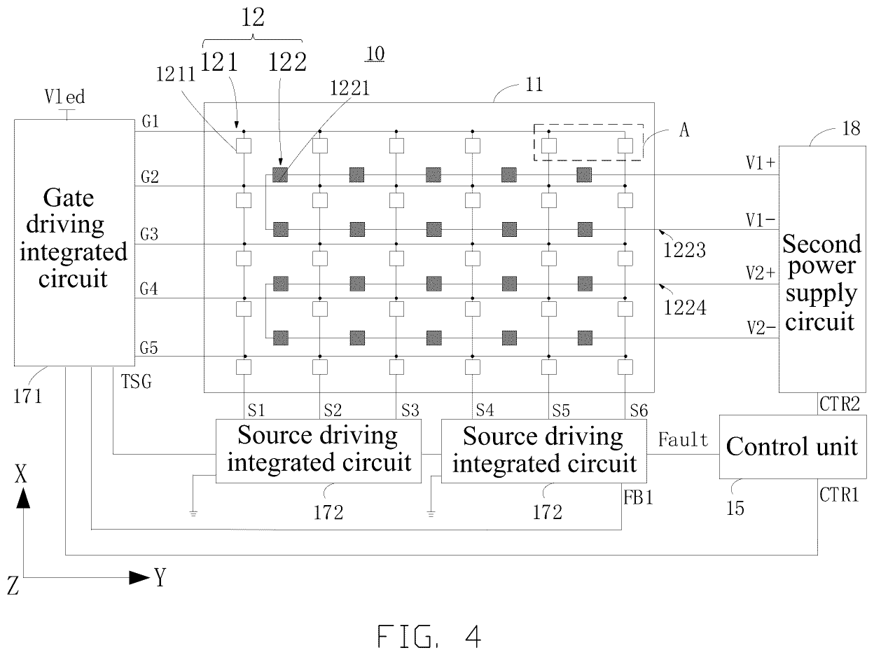

Please continue to refer to FIG. 4, in some embodiments, the sensing unit 14 may be arranged in the first power supply circuit 17. For example, the sensing unit 14 may be a resistance detection type sensing element or a magnetic field detection type sensing element included in the source driving integrated circuit 172. For example, the sensing unit 14 may be a voltage detection element arranged on each source line in each source driving integrated circuit 172. Each source driving integrated circuit 172 can detect the voltage on the corresponding source line, thereby determining that the corresponding source line is abnormal or an abnormal loop exists on the source line. That is, the sensing element in the source driving integrated circuit 172 can be directly used as the sensing unit 14. Thus, the circuit connection method in the display system 10 shown in FIG. 4 is substantially the same as the circuit connection method in the display system 10 shown in FIG. 2, except that one end of a link formed by connecting a plurality of source driving integrated circuits 172 in series is connected to the gate driving integrated circuit 171, and the other end is connected to the control unit 15, so as to output an abnormal signal Fault to the control unit 15 when an abnormality occurs in the source line. In this way, the link formed by connecting the plurality of source driving integrated circuits 172 in series transmits the timing signal TSG to each other and also transmits the detection result of the source line corresponding to each source driving integrated circuit 172 in sequence. For example, the abnormal signal Fault may include the number of the source line where the abnormality occurs, such as S1-S6. In this way, the control unit 15 can determine the first light source 1211 of the first light source group 121 that has an abnormality according to the number of the source line in which the abnormality occurs and the timing signal for controlling the gate driving integrated circuit 171.

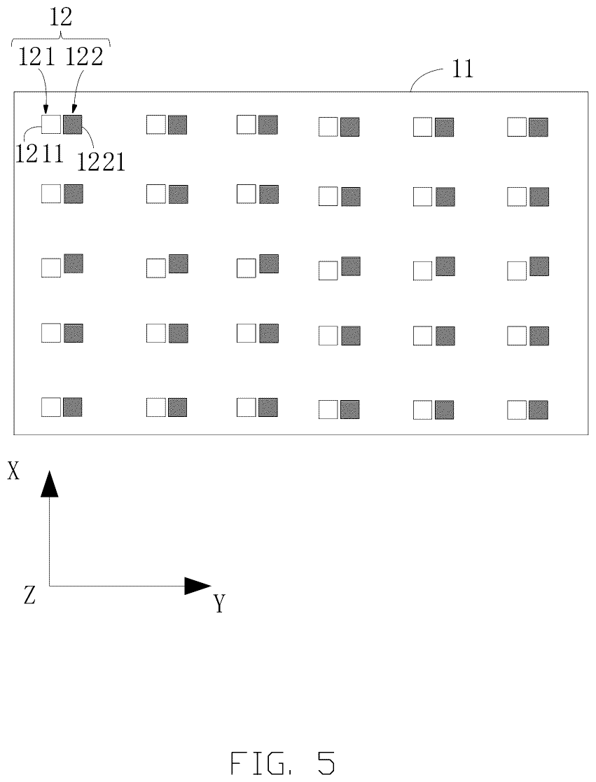

The present application does not limit the specific arrangement of the first light source group 121 and the second light source group 122. For example, please continue to refer to FIG. 5, the first light source group 121 and the second light source group 122 are also arranged evenly and staggered. In some embodiments, the first light source group 121 and the second light source group 122 are arranged evenly and adjacently. Specifically, each first light source 1211 of the first light source group 121 can be arranged adjacent to each second light source 1221 of the second light source group 122. More specifically, each column of first light sources 1211 of the first light source group 121 may be arranged adjacent to each column of second light sources 1221 of the second light source group 122. In this way, the first light source group 121 and the second light source group 122 are both arranged in an array in the active area of the display panel 11, and the number of the first light sources 1211 of the first light source group 121 and the number of the second light sources 1221 of the second light source group 122 may be equal. In other embodiments, the first light source group 121 and the second light source group 122 may be arranged on the display panel 11 in other ways.

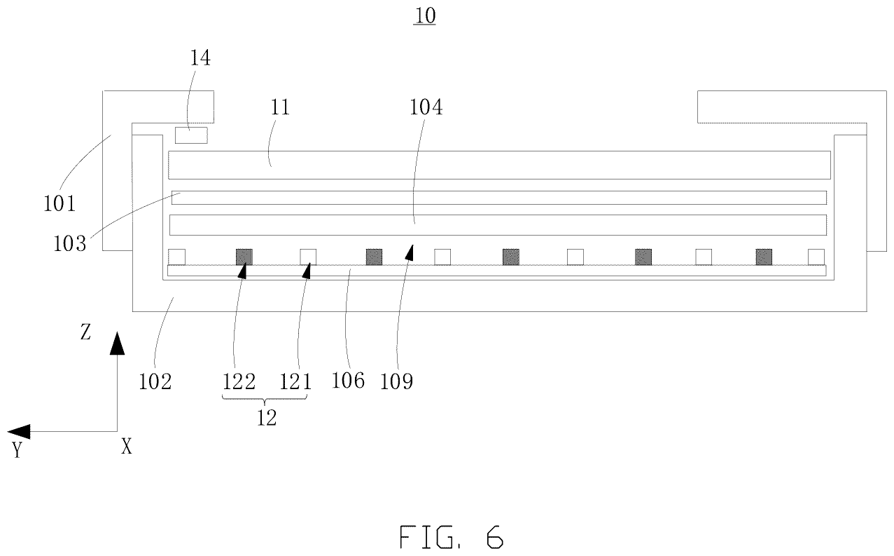

Please refer to FIG. 6, which is a partial cross-sectional schematic diagram of the display system shown from the viewing angle a of FIG. 2 when the display system provided by an embodiment of the present application forms a direct-type planar light source. In some embodiments, when the display system 10 forms the direct-lit planar light source, the display system 10 includes a front cover 101, a rear cover 102, an optical film 103, a diffusion plate 104, the first light source group 121, and the second light source group 122. The first light source group 121 and the second light source group 122 may be arranged on the circuit board 106. At this time, the display panel 11 may include liquid crystal glass. Specifically, the front cover 101 and the rear cover 102 cover each other to form an accommodating space 109. The accommodation space 109 is used to accommodate the display panel 11, the optical film 103, the diffusion plate 104, the first light source group 121, the second light source group 122, and the circuit board 106. The diffusion plate 104 is arranged on a side of the display panel 11 away from the light emitting side, and the optical film 103 is arranged on a side of the diffusion plate 104 close to the display panel 11. The optical film 103 is used to increase brightness, and the diffusion plate 104 is used to even out light. In this way, the light emitted by the first light source group 121 or the second light source group 122 can be transmitted to the display panel 11 through the diffusion plate 104 and the optical film 103, so that the display panel 11 displays images.

Furthermore, the sensing unit 14 may also include a light sensing unit. At this time, the sensing unit 14 as a light sensing unit can be set between the display panel 11 and the front cover 101, and the sensing unit 14 is electrically connected to the control unit 15 (the control unit 15, the first power supply circuit 17 and the second power supply circuit 18 are not shown in FIG. 6) to output a light detection result to the control unit 15. For example, when the sensing unit 14 is a light sensing unit, the brightness of the display panel 11 can be detected by the sensing unit 14, so that when the brightness is not within a preset range, an abnormal detection result is output to the control unit 15. In this way, when the first light source group 121 is working and it is determined that the brightness of the display panel 11 is abnormal, the control unit 15 can control the second light source group 122 to work so that the display panel 11 displays images.

### Scene 2

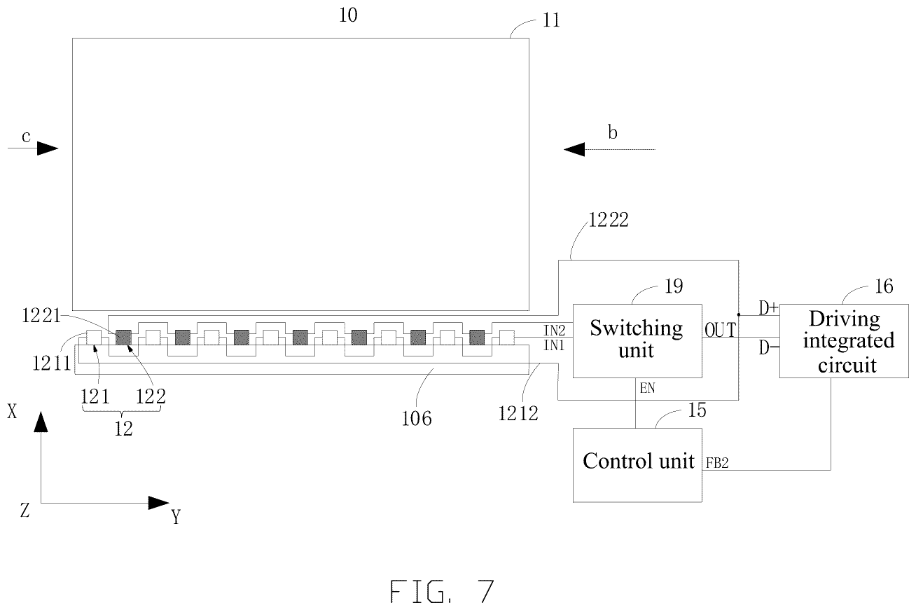

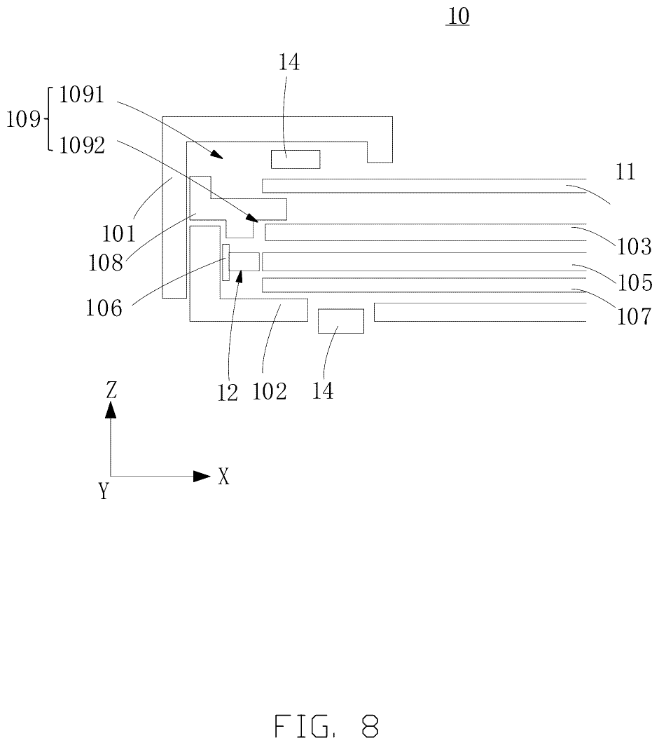

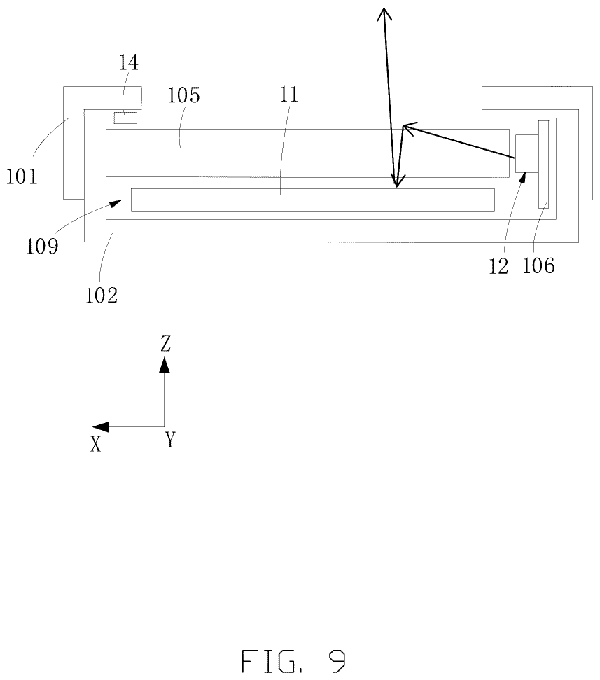

Please continue to refer to FIG. 7, which is a circuit diagram of the display system 10 provided in an embodiment of the present application when forming an edge-lit planar light source. In some embodiments, the first light source group 121 and the second light source group 122 are alternately arranged, and the first light source group 121 and the second light source group 122 are arranged outside the active area of the display panel 11. At this time, the display system 10 further includes a light guide plate 105 (please refer to FIG. 8 and FIG. 9). The light guide plate 105 is used to uniformly guide the light emitted by the first light source group 121 or the second light source group 122 to the display panel 11. According to the different positional relationships between the light guide plate 105 and the display panel 11, the light guide plate 105, the first light source group 121 and the second light source group 122 together form a backlight module or a frontlight module in the edge-lit planar light source. The first light source group 121 and the second light source group 122 are both arranged outside the effective area of the display panel 11, which means that a projection area of the positions where the first light source group 121 and the second light source group 122 are arranged along the Z-axis direction of the display system 10 does not overlap with a projection area of the effective area of the display panel 11 along the Z-axis direction of the display system 10.

Please refer to FIG. 7, in some embodiments, the first light source group 121 and the second light source group 122 in the display system 10 are both arranged on one side of the light guide plate 105, and from the cross-sectional view when the display system 10 forms the side-lit planar light source (please refer to FIG. 8 and FIG. 9), the first light source group 121, the second light source group 122 and the light guide plate 105 are located in the same plane, and the light emitted by the first light source group 121 and the second light source group 122 are roughly parallel to the plane where the light guide plate 105 is located. The first light source group 121 includes a plurality of first light sources 1211. The second light source group 122 includes a plurality of second light sources 1221. The first light source group 121 and the second light source group 122 are also arranged evenly and staggered. The first light sources 1211 and the second light sources 1221 are alternately arranged in sequence to form a row of LED light strips arranged on one side of the light guide plate 105. The display system 10 further includes a circuit board 106, and the first light source group 121 and the second light source group 122 may be both arranged on the circuit board 106.

Please refer to FIG. 7, in this embodiment, the display system 10 can replace the first power supply circuit 17 and the second power supply circuit 18 with a driving integrated circuit 16, so that the driving integrated circuit 16 provides operating current for the first light source group 121 or the second light source group 122. That is, the driving integrated circuit 16 can be used to provide operating current to the first light source group 121. Furthermore, the display system 10 also includes a switching unit 19. The driving integrated circuit 16 is connected to the first light source group 121 or the second light source group 122 via the switching unit 19. When there is no abnormality in the first light source group 121, the control unit 15 controls the switching unit 19 to connect to the first light source group 121 to power the first light source group 121; when there is an abnormality in the first light source group 121, the control unit 15 controls the switching unit 19 to connect to the second light source group 122 to power the second light source group 122.

Specifically, the driving integrated circuit 16 includes a positive driving terminal D+ and a negative driving terminal D−. In this embodiment, the switch unit 19 may be an integrated circuit, and the switch unit 19 includes an output terminal OUT, a first input terminal IN1, a second input terminal IN2, and an enable terminal EN.

All the first light sources 1211 of the first light source group 121 are connected in series to form a first line 1212. All the second light sources 1221 of the second light source group 122 are connected in series to form a second line 1222. One end of the first line 1212 is connected to the positive driving terminal D+ of the driving integrated circuit 16, and the other end of the first line 1212 is connected to the first input terminal IN1 of the switching unit 19. One end of the second line 1222 is connected to the positive driving terminal D+ of the driving integrated circuit 16, and the other end of the second line 1222 is connected to the second input terminal IN2 of the switching unit 19. The output terminal OUT of the switching unit 19 is connected to the negative driving terminal D− of the driving integrated circuit 16. The control unit 15 is connected to the enable terminal EN of the switching unit 19. In other embodiments, one end of the first line 1212 may be connected to the negative driving terminal D− of the driving integrated circuit 16, and the other end of the first line 1212 may be connected to the first input terminal IN1 of the switching unit 19. One end of the second line 1222 is connected to the negative driving terminal D− of the driving integrated circuit 16, and the other end of the second line 1222 is connected to the second input terminal IN2 of the switching unit 19. The output terminal OUT of the switching unit 19 is connected to the positive driving terminal D+ of the driving integrated circuit 16. The control unit 15 is connected to the enable terminal EN of the switching unit 19.

When the first light source group 121 is not abnormal, the control unit 15 outputs an enable signal with a first level state to the enable terminal EN to control the switch unit 19 to connect to the first light source group 121 to supply power to the first light source group 121. When an abnormality occurs in the first light source group 121, the control unit 15 outputs the enable signal with a second level state to the enable terminal EN, and controls the switch unit 19 to be connected to the second light source group 122 to supply power to the second light source group 122. The first level state is one of a high level state and a low level state, and the second level state is the other of the high level state and the low level state.

In some embodiments, the sensing unit 14 may be arranged in the driving integrated circuit 16. For example, the sensing unit 14 may be a current sensing element for detecting the current of the positive driving terminal D+ in the driving integrated circuit 16, or a voltage sensing element for detecting the voltage of the positive driving terminal D+ in the driving integrated circuit 16. Thus, when the driving integrated circuit 16 is connected to the first light source group 121 and detects that the current or voltage of the positive driving terminal D+ is abnormal (for example short circuit or open circuit), the driving integrated circuit 16 outputs the second feedback signal FB2 to the control unit 15. After receiving the second feedback signal FB2, the control unit 15 controls the switching unit 15 to be connected to the second light source group 122. The circuit shown in FIG. 7 is only used to illustrate the working principle of the present application, and does not limit the circuit configuration method in the present application.

Please continue to refer to FIG. 8, in this embodiment, when the light guide plate 105, the first light source group 121 and the second light source group 122 jointly form a backlight module in the side-lit planar light source, the display system 10 may include a front cover 101, a rear cover 102, a display panel 11, an optical film 103, a light guide plate 105, a reflective plate 107, a frame 108, and a light source module 12. The light source module 12 can be arranged on the circuit board 106. The light source module 12 includes a first light source group 121 (not shown) and a second light source group 122 (not shown). FIG. 8 does not show the control unit 15, the driving integrated circuit 16 and the switching unit 19. At this time, the display panel 11 may include liquid crystal glass. Specifically, the front cover 101 and the rear cover 102 cover each other to form an accommodating space 109. The frame 108 is arranged between the front cover 101 and the rear cover 102, and is used to separate the accommodating space 109 into a first accommodating space 1091 and a second accommodating space 1092. The first accommodating space 1091 is formed between the front cover 101 and the frame 108, and the second accommodating space 1092 is formed between the rear cover 102 and the frame 108. The display panel 11 is arranged in the first accommodating space 1091. The optical film 103, the light guide plate 105, the reflective plate 107, the frame 108, and the light source module 12 may be arranged in the second accommodation space 1092. The light guide plate 105 is arranged on a side of the display panel 11 away from the light emitting side, and the optical film 103 is arranged on a side of the light guide plate 105 close to the display panel 11. The reflective plate 107 is arranged on a side of the light guide plate 105 away from the optical film 103. The light source module 12 is arranged on one side of the light guide plate 105 and is located on the same plane as the light guide plate 105, and the plane is parallel to the plane where the display panel 11 is located. In this way, the light source module 12 provides backlight for the display panel 11.

Furthermore, in some embodiments, when the sensing unit 14 is a light sensing unit, the sensing unit 14 can be arranged between the display panel 11 and the front cover 101, and the sensing unit 14 can also be arranged close to the reflective plate 107 to detect the brightness of the light guide plate 105 passing through the display panel 11 or the reflective plate 107, and when the brightness of the light guide plate 105 passing through the display panel 11 or the reflective plate 107 is lower than the preset brightness of the light guide plate 105, the sensing unit 14 outputs a corresponding signal to the control unit 15, so that the control unit 15 controls the second light source group 122 to operate.

Please continue to refer to FIG. 9, in this embodiment, when the light guide plate 105, the first light source group 121 and the second light source group 122 jointly form a front light module in a side-lit planar light source, the display system 10 may include a front cover 101, a rear cover 102, a display panel 11, a light guide plate 105, and a light source module 12. The light source module 12 may be arranged on the circuit board 106. The light source module 12 includes a first light source group 121 (not shown) and a second light source group 122 (not shown). FIG. 9 does not show the control unit 15, the driving integrated circuit 16, and the switching unit 19. At this time, the display panel 11 may include reflective liquid crystal glass, cholesterol liquid crystal glass, etc., or the display panel 11 may be an electronic ink screen (E-link), that is, at this time, the display panel 11 is a reflective panel. Specifically, the front cover 101 and the rear cover 102 cover each other to form an accommodating space 109. The display panel 11 and the light guide plate 105 are arranged in the accommodating space 109. The light guide plate 105 is located at the light emitting side of the display panel 11. The light source module 12 is arranged on one side of the light guide plate 105 and is located on the same plane as the light guide plate 105, and the plane is parallel to the plane where the display panel 11 is located. In this way, the light emitted by the light source module 12 can be transmitted to the display panel 11 via the light guide plate 105 and then reflected outward by the display panel 11, that is, the light source module 12 provides front light for the display panel 11.

In the display system 10 shown in FIG. 9, when the sensing unit 14 is a light sensing unit, the sensing unit 14 may be arranged between the front cover 101 and the light guide plate 105. The sensing units 14 are electrically connected to the control unit 15 to output light detection results to the control unit 15. In this way, the brightness of the light guide plate 105 can be detected by the sensing unit 14, so that when the brightness is not within a preset range, an abnormal detection result is output. In some embodiments, the light guide plate 105 and the display panel 11 may be connected via an adhesive layer.

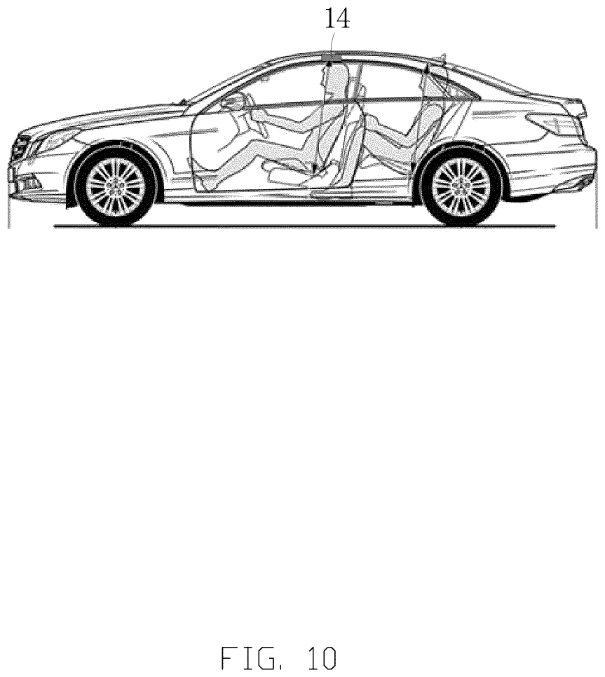

Please refer to FIG. 1 and FIG. 10, in the first embodiment or the second embodiment, the sensing unit 14 may further include an image acquisition unit, such as a camera. The sensing unit 14 is used to obtain the image displayed by the display system 10, and when the car is driving, if the sensing unit 14 determines that the image displayed by the display system 10 is abnormal (such as missing picture, black screen or abnormal brightness), the sensing unit 14 outputs the result indicating the detection abnormality to the control unit 15. In this way, the control unit 15 can control the second light source group 122 to work according to the detection result output by the sensing unit 14 so that the display system 10 can display images normally.

In the scene 1 or the scene 2, the at least one sensing unit 14 is arranged in the display system 10, and the sensing unit 14 may be a current sensing element, a voltage sensing element, a light sensing unit or an image acquisition unit.

Referring to FIG. 1 again, in other embodiments, the present application provides a display control module 20 applied in the display system 10 of any embodiment of the present application. The display control module 20 includes the first light source group 121, the second light source group 122, the sensing unit 14 and the control unit 15. The first light source group 121 includes the plurality of first light sources 1211. The second light source group 122 includes the plurality of second light sources 1221. The first light source group 121 and the second light source group 122 are arranged alternately. The sensing unit 14 is configured to detect whether the first light source group 121 is abnormal. The control unit 15 is configured to control the second light source group 122 to work when the first light source group 121 is detected to be abnormal by the sensing unit 14. The specific structure and working process of the display control module 20 can be found in the above contents and will not be described in detail here.

It should be noted that any steps and any technical features of the above-mentioned embodiments of the present application can be freely and arbitrarily combined, and the combined technical solutions are also within the scope of the present application.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure, up to and including the full extent established by the broad general meaning of the terms used in the claims.

What is claimed is:

1. A display control module, comprising:
a first light source group comprising a plurality of first light sources;
a second light source group comprising a plurality of second light sources, the first light source group and the second light source group arranged alternately;
a sensing unit configured to detect whether the first light source group is abnormal; and
a control unit configured to control the second light source group to work when the first light source group is detected to be abnormal by the sensing unit.

2. The display control module of claim 1, wherein an operating power of the second light source group to be less than an operating power of the first light source group.

3. The display control module of claim 1, wherein the sensing unit comprises a current sensing element, the current sensing element is configured to detect whether a current of the first light source group is greater than a preset current range, when the current sensing element detects the current of the first light source group is greater than the preset current range, the first light source group is determined to be abnormal.

4. The display control module of claim 3, wherein the current sensing element comprises resistance detection type sensing elements and magnetic field detection type sensing elements.

5. The display control module of claim 1, wherein the sensing unit comprises a voltage sensing element, the voltage sensing element is configured to detect whether a voltage of the first light source group is greater than a preset voltage range, when the voltage sensing element detects the voltage of the first light source group is greater than the preset voltage range, the first light source group is determined to be abnormal.

6. The display control module of claim 1, wherein the first light source group and the second light source group are arranged within an active area of a display panel; or the first light source group and the second light source group are arranged outside of the active area of the display panel.

7. The display control module of claim 6, wherein when the first light source group and the second light source group are arranged within an active area of the display panel, the display system comprises a first power supply circuit and a second power supply circuit, the first power supply circuit is electrically connected to the first light source group and is configured to supply power to the first light source group, the second power supply circuit is electrically connected to the second light source group to supply power to the second light source group;
when the control unit is further configured to determine that a number of abnormal first light sources of the first light source group reaches a preset range, the control unit further controls the second power supply circuit to supply power to the second light source group.

8. The display control module of claim 7, wherein the sensing unit is arranged on the first power supply circuit, the first power supply circuit is configured to provide working current to the first light source group.

9. The display control module of claim 6, wherein when the first light source group and the second light source group are arranged outside of the active area of the display panel, the display system comprises a switching unit and a driving integrated circuit, the driving integrated circuit is connected to the first light source group or the second light source group through the switching unit, when the first light source group has no abnormality, the control unit controls the switching unit to be connected to the first light source group to supply power to the first light source group, when the first light source group is abnormal, the control unit controls the switching unit to be connected to the second light source group to supply power to the second light source group.

10. The display control module of claim 9, wherein the sensing unit is arranged on the driving integrated circuit, the driving integrated circuit is configured to provide working current to the first light source group.

11. A display system, comprising:
a display panel;
a first light source group comprising a plurality of first light sources configured to enable the display panel to display images;
a second light source group comprising a plurality of second light sources, the first light source group and the second light source group arranged alternately;
a sensing unit configured to detect whether the first light source group is abnormal; and
a control unit configured to control the second light source group to work when the first light source group is detected to be abnormal by the sensing unit.

12. The display system of claim 11, wherein an operating power of the second light source group to be less than an operating power of the first light source group.

13. The display system of claim 11, wherein the sensing unit comprises a current sensing element, the current sensing element is configured to detect whether a current of the first light source group is greater than a preset current range, when the current sensing element detects the current of the first light source group is greater than the preset current range, the first light source group is determined to be abnormal.

14. The display system of claim 13, wherein the current sensing element comprises resistance detection type sensing elements and magnetic field detection type sensing elements.

15. The display system of claim 11, wherein the sensing unit comprises a voltage sensing element, the voltage sensing element is configured to detect whether a voltage of the first light source group is greater than a preset voltage range, when the voltage sensing element detects the voltage of the first light source group is greater than the preset voltage range, the first light source group is determined to be abnormal.

16. The display system of claim 11, wherein the first light source group and the second light source group are arranged within an active area of the display panel; or the first light source group and the second light source group are arranged outside of the active area of the display panel.

17. The display system of claim 16, wherein when the first light source group and the second light source group are arranged within an active area of the display panel, the display system comprises a first power supply circuit and a second power supply circuit, the first power supply circuit is electrically connected to the first light source group and is configured to supply power to the first light source group, the second power supply circuit is electrically connected to the second light source group to supply power to the second light source group;
when the control unit is further configured to determine that a number of abnormal first light sources of the first light source group reaches a preset range, the control unit further controls the second power supply circuit to supply power to the second light source group.

18. The display system of claim 17, wherein the sensing unit is arranged on the first power supply circuit, the first power supply circuit is configured to provide working current to the first light source group.

19. The display system of claim 16, wherein when the first light source group and the second light source group are arranged outside of the active area of the display panel, the display system comprises a switching unit and a driving integrated circuit, the driving integrated circuit is connected to the first light source group or the second light source group through the switching unit, when the first light source group has no abnormality, the control unit controls the switching unit to be connected to the first light source group to supply power to the first light source group, when the first light source group is abnormal, the control unit controls the switching unit to be connected to the second light source group to supply power to the second light source group.

20. The display system of claim 19, wherein the sensing unit is arranged on the driving integrated circuit, the driving integrated circuit is configured to provide working current to the first light source group.
